(19) United States
(12) Patent Application Publication
(10) Pub. No.: US 2026/0214136 A1
(43) Pub. Date: Jul. 23, 2026

(54) MANAGEMENT COMPONENT TRANSPORT PROTOCOL PROCESSING SYSTEM AND METHOD OF PROCESSING THE SAME

(71) Applicant: SK hynix Inc., Gyeonggi-do (KR)

(72) Inventors: Hyun Woo BAE, Gyeonggi-do (KR); Sung Su KIM, Gyeonggi-do (KR)

(21) Appl. No.: 19/246,704

(22) Filed: Jun. 24, 2025

(30) Foreign Application Priority Data
Jan. 23, 2025 (KR) 10-2025-0010361

(51) Int. Cl. H04L 67/01; G06F 9/54

(52) U.S. Cl. CPC H04L 67/01; G06F 9/544

(57) ABSTRACT

An MCTP processing system comprises an MCTP processor configured to process an MCTP message; N protocol processors each configured to process a protocol message including one or more MCTP messages; a physical binding module configured to generate MCTP packets based on data received from a host through M physical interfaces; a central packet manager comprising M physical binding groups corresponding to the M physical interfaces, respectively, each physical binding group comprising K MCTP entry queues configured to store an MCTP entry; and a shared memory comprising one or more slots configured to store an MCTP message corresponding to the MCTP entry, which is generated based on the MCTP packets generated by the physical binding module.

### CROSS-REFERENCES TO RELATED APPLICATION

The present application claims priority under 35 U.S.C. 119(a) to Korean patent application No. 10-2025-0010361 filed on Jan. 23, 2025, which is incorporated herein by reference in its entirety.

### BACKGROUND

### 1. Technical Field

Embodiments of the present disclosure relate to a management component transport protocol (MCTP) processing system and a method of operating the same.

### 2. Related Art

MCTP is a protocol that supports communication among various intelligent hardware components constituting a platform management subsystem, providing monitoring and control functions within a computer system.

MCTP is independent of the underlying physical bus characteristics and the data link layer messages used on the bus. By using MCTP, various management commands may be transmitted through alternative types of links.

### SUMMARY

Embodiments of the present disclosure may provide an MCTP processing system that supports an architecture enabling efficient resource management and real-time synchronization among multiple processors and a method of processing the same.

Additionally, embodiments of the present disclosure may provide an MCTP processing system that allows independent operation and resource management for each of multiple physical bindings and a method of processing the same.

The objects of embodiments of the present disclosure are not limited to those set forth herein, and other unmentioned objects will be apparent to those skilled in the art from the following description.

Embodiments of the present disclosure may provide an MCTP processing system including an MCTP processor configured to process MCTP messages; N protocol processors each configured to process a protocol message including one or more MCTP messages; a physical binding module configured to generate an MCTP packet based on data received from a host through M physical interfaces; a central packet manager including M physical binding groups corresponding to the M physical interfaces, respectively, each physical binding group including K MCTP entry queues configured to store an MCTP entry; and a shared memory including one or more slots configured to store an MCTP message corresponding to the MCTP entry, which is generated based on one or more MCTP packets generated by the physical binding module.

Embodiments of the present disclosure may provide a method of processing MCTP including generating MCTP packets based on data received from a host through a target physical interface among M physical interfaces; generating an MCTP message based on the MCTP packet; storing the MCTP message in a slot included in shared memory; setting an MCTP entry stored in one of K MCTP entry queues included in a target physical binding group among M physical binding groups to correspond to the slot storing the MCTP message; and assessing the MCTP message using the MCTP entry by at least one of an MCTP processor processing an MCTP message and N protocol processors processing protocol messages including one or more MCTP messages. The target physical binding group refers to the physical binding group corresponding to the target physical interface, among the M physical binding groups corresponding to one of the M physical interfaces, respectively.

According to embodiments of the present disclosure, an MCTP processing system and a method of processing the same may be provided, supporting a configuration that enables efficient resource management and real-time synchronization among multiple processors while allowing independent operation and resource management for each of multiple physical bindings.

The embodiments of the present disclosure are not limited to the above-described embodiments, and other embodiments will be apparent to those skilled in the art from the following detailed description.

### BRIEF DESCRIPTION OF THE DRAWINGS

The embodiments of the present disclosure will be more fully understood from the following detailed description and the accompanying drawings, which are provided for illustration purposes only and are not intended to limit the embodiments.

FIG. 1 is a diagram illustrating a configuration of an MCTP processing system according to an embodiment of the present disclosure.

FIG. 2 is a diagram illustrating a configuration of an MCTP processor and N protocol processors according to an embodiment of the present disclosure.

FIG. 3 is a diagram for describing an operation in which an MCTP processing system generates an MCTP message from an MCTP packet, according to an embodiment of the present disclosure.

FIG. 4 is a diagram illustrating an MCTP entry according to an embodiment of the present disclosure.

FIG. 5 is a diagram for describing an operation in which an MCTP processing system updates a first MCTP entry, according to an embodiment of the present disclosure.

FIG. 6 is a diagram illustrating an operation of an MCTP processing system according to an embodiment of the present disclosure.

FIG. 7 is a diagram illustrating an MCTP processing method according to an embodiment of the present disclosure.

### DETAILED DESCRIPTION

Hereinafter, embodiments of the disclosure are described in detail with reference to the accompanying drawings. In assigning reference numerals to components of each drawing, the same components may be assigned the same numerals even when they are shown on different drawings. When determined to make the subject matter of the disclosure unclear, the detailed of the known art or functions may be skipped. As used herein, when a component “includes,” “has,” or “is composed of” another component, the component may add other components unless the component “only” includes, has, or is composed of” the other component. As used herein, the singular forms “a”, “an” and “the” are intended to include the plural forms as well, unless the context clearly indicates otherwise.

Labels such as “first,” “second,” “A,” “B,” “(a),” and “(b),” may be used in describing the components of the embodiments of the present disclosure. These labels are provided merely to distinguish a component from another, and the essence, order, or number of the components are not limited by the labels.

In describing the positional relationship between components, when two or more components are described as “connected”, “coupled” or “linked”, the two or more components may be directly “connected”, “coupled” or “linked””, or another component may intervene. Here, the other component may be included in one or more of the two or more components that are “connected”, “coupled” or “linked” to each other.

When such terms as, e.g., “after”, “next to”, “after”, and “before”, are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the present disclosure are described in detail with reference to the accompanying drawings.

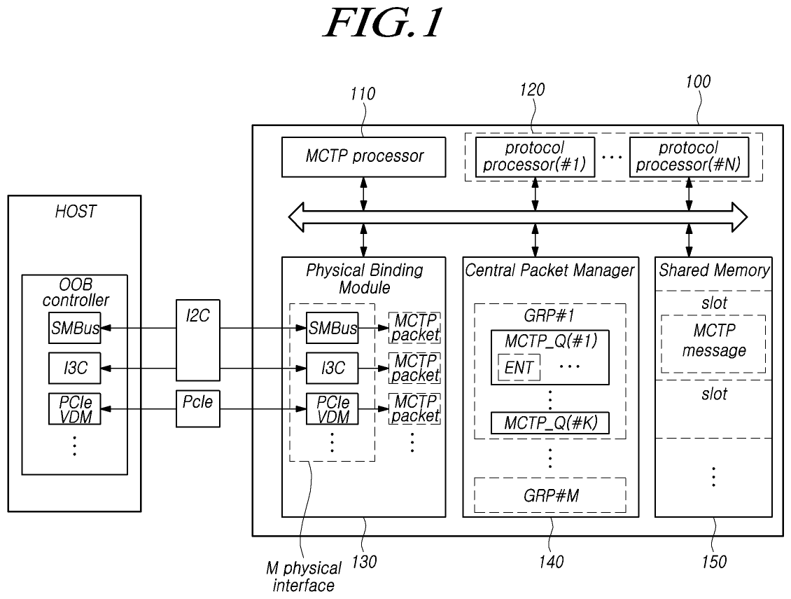

FIG. 1 is a diagram illustrating a configuration of an MCTP processing system 100 according to an embodiment of the present disclosure.

Referring to FIG. 1, the MCTP processing system 100 may include an MCTP processor 110, N protocol processors 120, a physical binding module 130, a central packet manager 140, and a shared memory 150.

The MCTP processor 110 may process an MCTP message (e.g., an MCTP control message).

The N protocol processors 120, where N is a natural number may each process a protocol message composed of one or more MCTP messages. The protocol message may be a message transmitted and received over MCTP (e.g., NVMe-MI, SPDM).

The physical binding module 130 may generate MCTP packets based on data received from a host HOST through M physical interfaces (e.g., SMBus, I3C, PCIe VDM), where M is a natural number.

The M physical interfaces may independently receive data and have independent error handling conditions (e.g., sanity check, timeout, discard, drop, retry). Additionally, the size of the generated MCTP packets may vary depending on the physical interface.

The physical binding module 130 may receive data via an out-of-band (OOB) method from an OOB controller of the host HOST.

To generate MCTP packets based on data received from the host HOST, the physical binding module 130 may execute M packet handlers, each corresponding to one of the M physical interfaces. The packet handler may be a module that extracts the header and payload of an MCTP packet from the data received through the physical interface.

The central packet manager 140 may include M physical binding groups GRP #1, . . . , GRP #M, each corresponding to one of the M physical interfaces. Each of the M physical binding groups GRP #1, . . . , GRP #M may include K MCTP entry queues MCTP_Q #1, . . . , MCTP_Q #K, where K is a natural number 2 or more, each of which is capable of storing an MCTP entry ENT. In this case, each of the K MCTP entry queues MCTP_Q #1, . . . , MCTP_Q #K may indicate the state of the MCTP message corresponding to a queued MCTP entry, such as FREE, ASSEMBLY, ACCEPTED, or PROCESS.

By independently managing physical binding groups for the M physical interfaces, the central packet manager 140 enables independent operation and resource management for the M physical interfaces.

The MCTP entry ENT may include information about its corresponding MCTP message. The MCTP message may be generated based on one or more MCTP packets generated by the physical binding module 130. The MCTP entry ENT may have a fixed size (e.g., 40 bytes).

Instead of directly managing MCTP messages, the central packet manager 140 manages them via the MCTP entry ENT, enabling efficient resource management and real-time synchronization.

The MCTP processor 110 and the N protocol processors 120 may monitor enqueue and dequeue events of MCTP entries in one or more of the K MCTP entry queues MCTP_Q #1, . . . , MCTP_Q #K within a target physical binding group, which corresponds to one of the M physical binding groups GRP #1, . . . , GRP #M.

Through this process, the MCTP processor 110 and the N protocol processors 120 may monitor MCTP entries, allowing them to share resources and synchronize the processing status of MCTP messages in real time.

The shared memory 150 may include one or more slots capable of storing MCTP messages. The shared memory 150 is accessible by the MCTP processor 110, the N protocol processors 120, and the central packet manager 140.

In embodiments of the present disclosure, the MCTP processing system 100, as well as the MCTP processor 110, the N protocol processors 120, the physical binding module 130, the central packet manager 140, and the shared memory 150 included in the MCTP processing system 100, may be implemented in various ways.

For example, MCTP processing system 100 may be a memory system capable of storing data (e.g., SSD (Solid State Drive), HDD (Hard Disk Drive), CXL (Compute Express Link), or UFS (Universal Flash Storage)).

For example, the MCTP processor 110 and the N protocol processors 120 may each be implemented as a processing unit capable of performing logical operations (e.g., CPU (Central Processing Unit), GPU (Graphics Processing Unit), AP (Application Processor), or a microprocessor).

For example, the physical binding module 130 may be implemented as a physical interface module capable of processing M physical interfaces.

For example, the central packet manager 140 may be implemented as a hardware module including volatile/non-volatile memory capable of storing data (e.g., SRAM, DRAM, or NAND flash).

For example, the shared memory 150 may be implemented as volatile memory (e.g., SRAM or DRAM).

In embodiments of the present disclosure, communication between the MCTP processor 110, the N protocol processors 120, the physical binding module 130, the central packet manager 140, and the shared memory 150 may be performed through a bus or other channels.

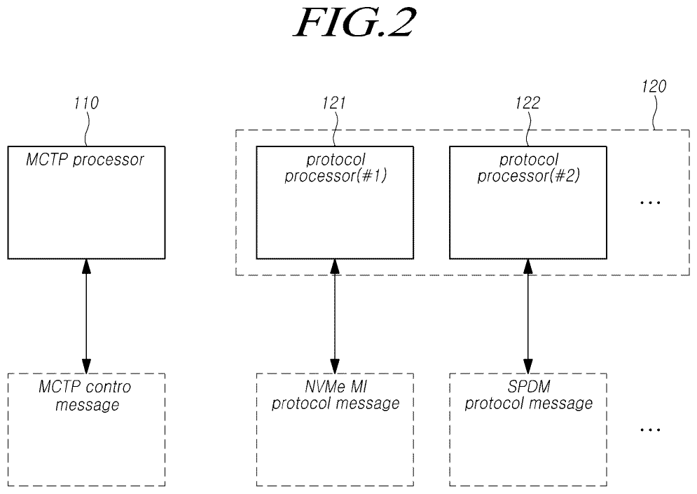

FIG. 2 is a diagram illustrating a configuration of the MCTP processor 110 and the N protocol processors 120 according to an embodiment of the present disclosure.

Referring to FIG. 2, as described above, the MCTP processor 110 may process MCTP control messages.

In FIG. 2, N may be two or more. In this case, among the N protocol processors 120, a first protocol processor 121 may process NVMe MI (Management Interface) messages, and a second protocol processor 122 may process SPDM (Security Protocol and Data Model) messages.

NVMe MI messages may be used to discover, monitor, configure, and update NVMe devices in various operating environments.

SPDM messages may be used to ensure the integrity, confidentiality, and availability of information by performing device authentication and data protection between various systems.

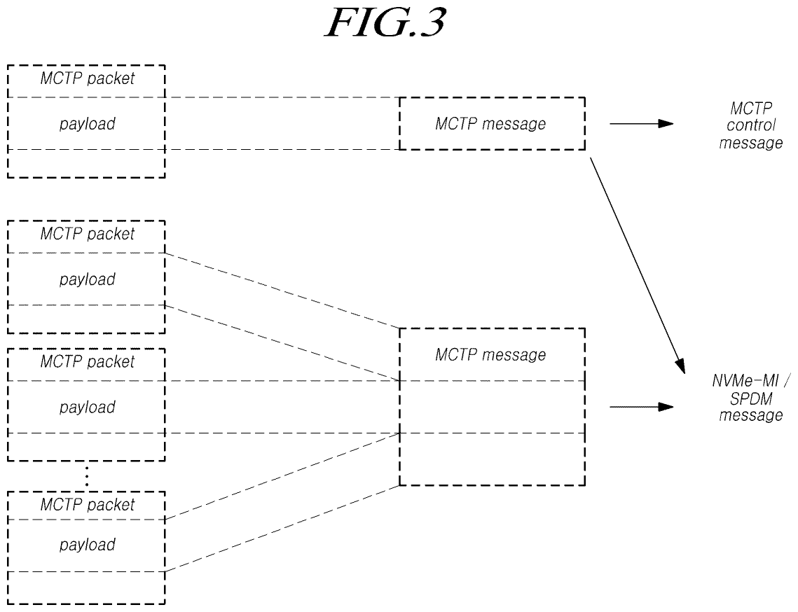

FIG. 3 is a diagram for describing an operation in which the MCTP processing system 100 generates an MCTP message from an MCTP packet, according to an embodiment of the present disclosure.

Referring to FIG. 3, MCTP processing system 100 may generate an MCTP message from a single MCTP packet or by combining multiple MCTP packets.

For example, MCTP processing system 100 may generate an MCTP message from the payload contained in a single MCTP packet. In this case, the generated MCTP message may be an MCTP control message, a NVMe MI message, or a SPDM message.

In another embodiment, MCTP processing system 100 may generate an MCTP message by combining the payloads contained in multiple MCTP packets. In this case, the generated MCTP message may be a NVMe MI message or a SPDM message.

In embodiments of the present disclosure, the operation of generating an MCTP message from an MCTP packet may be performed by the MCTP processor 110.

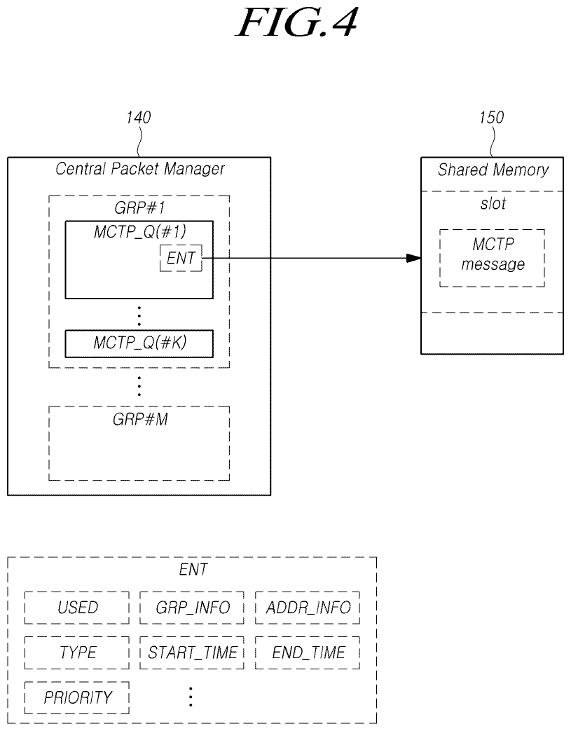

FIG. 4 is a diagram illustrating an MCTP entry ENT according to an embodiment of the present disclosure.

As described above, the central packet manager 140 may include M physical binding groups GRP #1, . . . , GRP #M, each corresponding to one of the M physical interfaces. Each of the M physical binding groups GRP #1, . . . , GRP #M may include K MCTP entry queues MCTP_Q #1, . . . , MCTP_Q #K capable of storing an MCTP entry ENT.

Among the M physical binding groups GRP #1, . . . , GRP #M, an MCTP entry ENT may be stored in a first MCTP entry queue MCTP_Q #1 among the K MCTP entry queues MCTP_Q #1, . . . , MCTP_Q #K included in a first physical binding group GRP #1. The MCTP entry ENT may correspond to an MCTP message stored in a slot allocated in the shared memory 150.

In this case, the MCTP entry ENT may include at least one of the following: 1) Information USED indicating whether the MCTP entry ENT is in use, 2) Physical binding group information GRP_INFO indicating which of the M physical binding groups GRP #1, . . . , GRP #M the MCTP entry ENT is included in, 3) Address information ADDR_INFO on the shared memory 150 of a slot, which stores the MCTP message corresponding to the MCTP entry ENT, 4) Type information TYPE indicating the MCTP entry queue corresponding to the MCTP entry ENT in the physical binding group containing the MCTP entry ENT, where the MCTP entry queue indicates the state of the MCTP entry ENT, 5) Start time information START_TIME, indicating when the MCTP packet corresponding to the MCTP message corresponding to the MCTP entry ENT was first generated by being received through the physical interface, 6) End time information END_TIME, indicating when the MCTP packet corresponding to the MCTP message corresponding to the MCTP entry ENT was last transmitted to the host HOST, and 7) Priority information PRIORITY, indicating the response priority of the MCTP message corresponding to the MCTP entry ENT (e.g., high priority or normal priority).

For example, the MCTP entry ENT may include all or only a subset of the information listed in items 1) to 7).

For example, the aforementioned start time information START_TIME and end time information END_TIME may be used to notify the host HOST of a delay in MCTP packet transmission or reception, determine whether to discard or drop the MCTP packet, or track the MCTP packet for debugging purposes.

For example, the aforementioned priority information PRIORITY may indicate either high priority, or normal priority, or one of multiple priority levels.

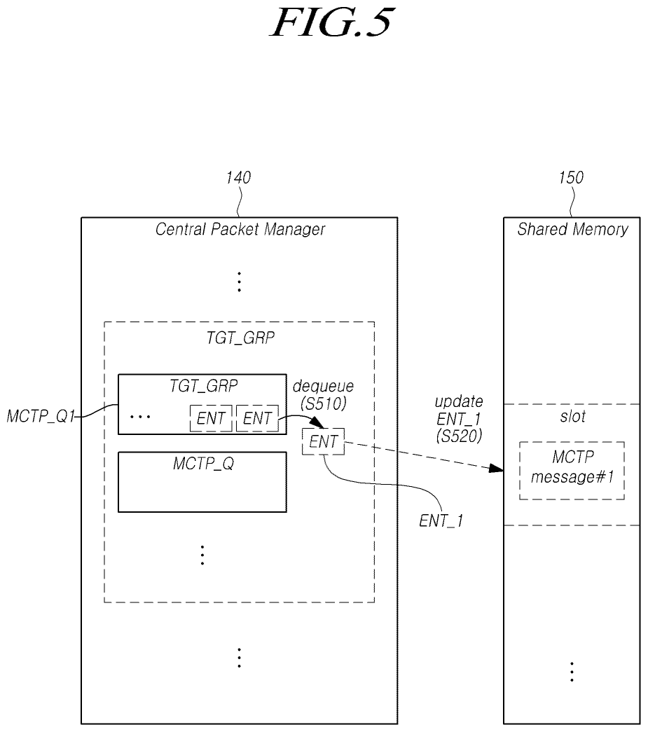

FIG. 5 is a diagram illustrating for describing an operation in which the MCTP processing system 100 updates a first MCTP entry, according to an embodiment of the present disclosure.

Referring to FIG. 5, the central packet manager 140 of the MCTP processing system 100 may dequeue the first MCTP entry ENT_1 from the first MCTP entry queue MCTP_Q1 among the MCTP entry queues MCTP_Q included in the target physical binding group TGT_GRP among the M physical binding groups (S510).

In this case, an MCTP entry stored in an MCTP entry queue MCTP_Q may be in a FREE state, meaning that it is not associated with any MCTP message.

Subsequently, the central packet manager 140 may update the first MCTP entry ENT_1 to correspond to the slot storing the first MCTP message (S520).

In this case, the first MCTP message may be an MCTP message generated from the MCTP packet received through a physical interface corresponding to the target physical binding group TGT_GRP.

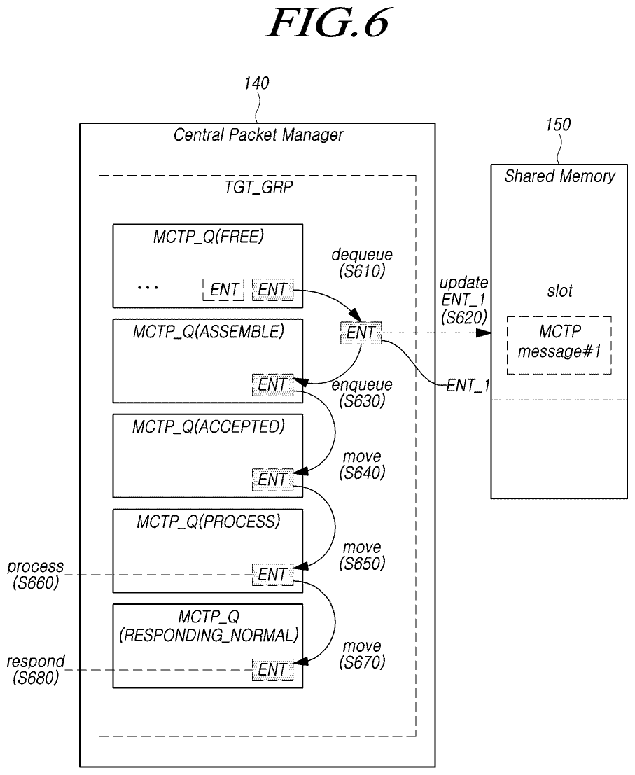

FIG. 6 is a diagram illustrating an operation of MCTP processing system 100 according to an embodiment of the present disclosure.

Referring to FIG. 6, the central packet manager 140 may dequeue the first MCTP entry ENT_1 from an MCTP queue storing FREE-state MCTP entries (S610).

When the host HOST transmits the MCTP packet to the physical binding module 130 of the MCTP processing system 100 through a specific physical interface (e.g., SMBus), the physical binding module 130 may receive the MCTP packet via the packet handler corresponding to the physical interface.

To process the received MCTP packet, the MCTP processor 110 may request the central packet manager 140 to dequeue the first MCTP entry ENT_1 in order to obtain the first MCTP entry in the FREE state.

Subsequently, the central packet manager 140 may update the first MCTP entry ENT_1 to correspond to a slot that can store the first MCTP message (S620).

Thereafter, the central packet manager 140 may enqueue the first MCTP entry ENT_1 into an MCTP queue storing ASSEMBLE-state MCTP entries (S630). Afterward, the MCTP packets used to generate the first MCTP message may be stored in the slot corresponding to the first MCTP entry ENT_1.

For example, among the N protocol processors 120, the first protocol processor that processes NVMe MI messages may monitor the MCTP queue storing ASSEMBLE-state MCTP entries to determine whether an NVMe MI message is being received.

Subsequently, when the physical binding module 130 completes the MCTP packets used to generate the first MCTP message, the central packet manager 140 may move the first MCTP entry ENT_1 to the MCTP queue storing ACCEPTED-state MCTP entries (S640). In this case, the MCTP processor 110 may request the central packet manager 140 to move the first MCTP entry ENT_1 to the MCTP queue storing ACCEPTED-state MCTP entries.

Afterward, the central packet manager 140 may move the first MCTP entry ENT_1 to an MCTP queue storing PROCESS-state MCTP entries (S650).

Then, the MCTP processor 110 or one of the N protocol processors 120 may execute a processing operation using the first MCTP entry ENT_1 (S660). For example, if the first MCTP message corresponding to the first MCTP entry ENT_1 is the NVMe MI message, the first protocol processor that processes the NVMe MI message may perform the aforementioned processing operation.

Afterward, the central packet manager 140 may move the first MCTP entry ENT_1 to the MCTP queue storing RESPONDING_NORMAL-state MCTP entries in order to respond to the host HOST (S670).

FIG. 6 illustrates an embodiment in which the priority is set to normal priority; however, the MCTP queue where the first MCTP entry ENT_1 is moved may vary depending on the priority information defined for the first MCTP entry ENT_1. For example, if the priority information defined for the first MCTP entry ENT_1 indicates high priority, the central packet manager 140 may move the first MCTP entry ENT_1 to the MCTP queue storing high-priority-state MCTP entries.

Subsequently, the MCTP processor 110 or one of the N protocol processors 120 may execute a response operation to the host HOST using the first MCTP entry ENT_1 (S680).

After the response is completed, the first MCTP entry ENT_1 may be moved to the MCTP queue storing TRANSMITTED-state MCTP entries or the MCTP queue storing FREE-state MCTP entries.

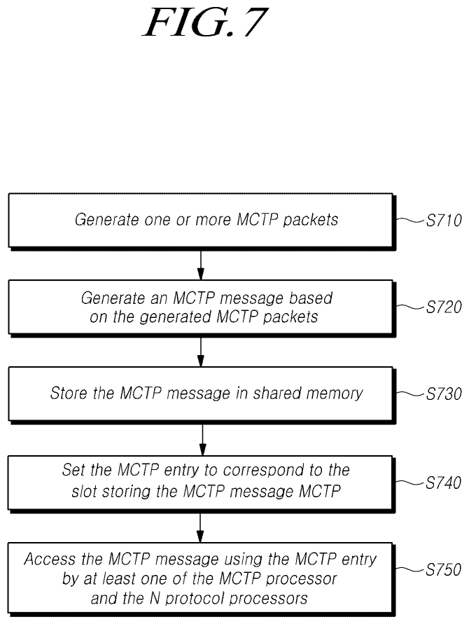

FIG. 7 is a diagram illustrating a method of processing MCTP according to an embodiment of the present disclosure.

Referring to FIG. 7, the method of processing MCTP may include an operation of generating one or more MCTP packets based on data received from a host HOST through a target physical interface among M physical interfaces, where M is a natural number 2 or more (S710).

The MCTP processing method may further include an operation of generating the MCTP message based on the MCTP packet generated in the operation S710 (S720).

The MCTP processing method may further include an operation of storing the MCTP message in a slot within the shared memory 150 (S730).

MCTP processing method may further include an operation of associating an MCTP entry, stored in one of the K MCTP entry queues MCTP_Q #1, . . . , MCTP_Q #K included in the target physical binding group, with a slot storing the MCTP message (S740).

For example, the MCTP entry may include at least one of: 1) Information indicating whether the MCTP entry is in use, 2) Information indicating the target physical binding group, 3) Address information in the shared memory 150 of a slot where the MCTP message is stored, 4) Type information indicating the MCTP entry queue corresponding to the MCTP entry within the target physical binding group, 5) Start time information, which indicates when the MCTP packet corresponding to the MCTP message was first generated, 6) End time information, which indicates when the MCTP packet corresponding to the MCTP message was last transmitted to the host, and 7) Priority information indicating the response priority of the MCTP message.

The MCTP processing method may further include an operation in which an MCTP message is accessed using the MCTP entry (S750) by at least one of the MCTP processor 110, which processes MCTP messages, and the N protocol processors 120, which process protocol messages composed of one or more MCTP messages.

For example, N may be two or more, and among the N protocol processors 120, the first protocol processor may process NVMe MI (Management Interface) protocol messages, while the second protocol processor may process SPDM (Security Protocol and Data Model) protocol messages.

For example, the operation S750 may include monitoring events in which the MCTP entry is enqueued or dequeued in one or more of the K MCTP entry queues MCTP_Q #1, . . . , MCTP_Q #K and wherein the target physical binding group includes the MCTP processor 110 and the N protocol processors 120.

In this case, the operation S750 may further include: an operation of dequeuing the MCTP entry from the first MCTP entry queue MCTP_Q #1 among the K MCTP entry queues MCTP_Q #1, . . . , MCTP_Q #K included in the target physical binding group, and an operation of updating the dequeued MCTP entry to correspond to a slot storing the MCTP message.

Although embodiments of the present disclosure have been described for illustrative purposes, those skilled in the art will appreciate that various modifications, additions, and substitutions are possible without departing from the scope and spirit of the present disclosure. Therefore, the embodiments disclosed above and in the accompanying drawings should be considered as illustrative rather than limiting the technological scope. The technological scope of the present disclosure is not limited to the embodiments and drawings described herein. The spirit and scope of the present disclosure should be interpreted in connection with the appended claims and encompass all equivalents within the scope of the appended claims. Furthermore, the embodiments may be combined to form additional embodiments.

What is claimed is:

1. A management component transport protocol (MCTP ) processing system comprising:
an MCTP processor configured to process an MCTP message;
N protocol processors each configured to process a protocol message including one or more MCTP messages;
a physical binding module configured to generate MCTP packets based on data received from a host through M physical interfaces;
a central packet manager comprising M physical binding groups corresponding to the M physical interfaces, respectively, each physical binding group comprising K MCTP entry queues configured to store an MCTP entry; and
a shared memory comprising one or more slots configured to store an MCTP message corresponding to the MCTP entry, which is generated based on the MCTP packets generated by the physical binding module,
wherein each of N, M, and K is a natural number.

2. The MCTP processing system of claim 1,
wherein N is 2 or more,
wherein a first protocol processor among the N protocol processors is configured to process NVMe management interface messages, and
wherein a second protocol processor among the N protocol processors is configured to process security protocol and data model (SPDM) messages.

3. The MCTP processing system of claim 1, wherein the MCTP entry comprises at least one of:
information indicating whether the MCTP entry is in use;
information on a physical binding group that comprises the MCTP entry, among the M physical binding groups;
address information on a slot of the shared memory, storing the MCTP message corresponding to the MCTP entry;
type information indicating an MCTP entry queue corresponding to the MCTP entry, within the physical binding group comprising the MCTP entry;
start time information indicating when an MCTP packet corresponding to the MCTP message corresponding to the MCTP entry is first generated;
end time information indicating when the MCTP packet corresponding to the MCTP message corresponding to the MCTP entry is last transmitted to the host; and
priority information indicating a response priority of the MCTP message corresponding to the MCTP entry.

4. The MCTP processing system of claim 1, wherein the MCTP processor and the N protocol processors are configured to monitor events in which the MCTP entry is enqueued or dequeued in at least one of the K MCTP entry queues included in a target physical binding group among the M physical binding groups.

5. The MCTP processing system of claim 4, wherein the central packet manager is configured to:
dequeue a first MCTP entry from a first MCTP entry queue among the K MCTP entry queues included in the target physical binding group; and
update the first MCTP entry to correspond to a slot storing a first MCTP message generated from an MCTP packet received through a physical interface corresponding to the target physical binding group, among the M physical interfaces.

6. A method of processing management component transport protocol (MCTP), the method comprising:
generating MCTP packets based on data received from a host through a target physical interface among M physical interfaces;
generating an MCTP message based on the MCTP packets;
storing the MCTP message in a slot included in a shared memory;
setting an MCTP entry stored in one of K MCTP entry queues included in a target physical binding group among M physical binding groups to correspond to the slot storing the MCTP message; and
assessing the MCTP message using the MCTP entry by at least one of an MCTP processor processing an MCTP message and N protocol processors processing protocol messages including one or more MCTP messages,
wherein the target physical binding group is a physical binding group corresponding to the target physical interface, among the M physical binding groups corresponding to one of the M physical interfaces, respectively, and
wherein each of N, M, and K is a natural number.

7. The method of claim 6, further comprising:
wherein N is 2 or more,
processing, by a first protocol processor among the N protocol processors, NVMe management interface protocol messages, and
processing, by a second protocol processor among the N protocol processors, security protocol and data model (SPDM) protocol messages.

8. The method of claim 6, wherein the MCTP entry includes at least one of:
information indicating whether the MCTP entry is in use,
information indicating the target physical binding group,
address information on the slot of the shared memory, storing the MCTP message,
type information indicating an MCTP entry queue corresponding to the MCTP entry, within the target physical binding group,
start time information indicating when an MCTP packet corresponding to the MCTP message is first generated,
end time information indicating when the MCTP packet corresponding to the MCTP message is last transmitted to the host, and
priority information indicating a response priority of the MCTP message.

9. The method of claim 6, wherein accessing the target MCTP message using the MCTP entry comprises monitoring, by the MCTP processor and the N protocol processors, events in which the MCTP entry is enqueued or dequeued in at least one of the K MCTP entry queues.

10. The method of claim 9, wherein accessing the MCTP message using the MCTP entry further comprises:
dequeuing the MCTP entry from a first MCTP entry queue among the K MCTP entry queues included in the target physical binding group; and
updating the dequeued MCTP entry to correspond to the slot storing the MCTP message.
